(19) United States
(12) Patent Application Publication
(10) Pub. No.: US 2024/0210183 A1
(43) Pub. Date: Jun. 27, 2024

(54) VEHICLE OPERATION MANAGEMENT SYSTEM

(71) Applicant: Toyota Jidosha Kabushiki Kaisha, Toyota-shi Aichi-ken (JP)

(72) Inventors: Shinya Shirakawa, Toyota-shi Aichi-ken (JP); Toru Takashima, Susono-Shi Shizuoka-ken (JP); Keigo Noguchi, Toyota-shi Aichi-ken (JP)

(73) Assignee: Toyota Jidosha Kabushiki Kaisha, Toyota-shi Aichi-ken (JP)

(21) Appl. No.: 18/543,711

(22) Filed: Dec. 18, 2023

(30) Foreign Application Priority Data
Dec. 27, 2022 (JP) 2022-210886

(51) Int. Cl. G01C 21/34; G01C 21/36; G06Q 10/02; G06Q 50/47

(52) U.S. Cl. CPC G01C 21/3438; G01C 21/3446; G01C 21/3461; G01C 21/3617; G06Q 10/02; G06Q 50/47

(57) ABSTRACT

A vehicle operation management system includes a processor. The processor determines candidates for travel routes based on a boarding request including boarding location information, alighting location information, and boarding time or alighting time transmitted from a plurality of passengers, and vehicle location information, evaluates the candidates, and selects a highly-rated travel route

### CROSS REFERENCE TO RELATED APPLICATION

This application claims priority to Japanese Patent Application No. 2022-210886 filed on Dec. 27, 2022, which is incorporated herein by reference in its entirety including the specification, claims, drawings, and abstract.

### TECHNICAL FIELD

The present disclosure relates to a vehicle operation management system.

### BACKGROUND

In recent years, in addition to the use of shared-ride cabs and the like, there has been an increase in the provision of shared-ride public transportation services that operate in response to user demand. In such shared-ride services, a vehicle operation management system has been proposed to set up and manage vehicle operation plans to improve convenience for multiple users.

For example, JP-2022-021873-A discloses an information processing system for determining a schedule for a vehicle in which multiple users ride together. The information processing device groups a plurality of ride requests by respective ride points and determines the arrival time of the vehicle for each group. With such a configuration, multiple users who have transmitted individual ride requests can be allowed to board the vehicle at the same time. As a result, transportation efficiency is said to be improved.

### CITATION LIST

### Patent Literature

Patent Document 1: JP-2022-021873-A

### SUMMARY

In the case of a shared-ride service where multiple passengers board from the same location at the same time, each passenger may have a different destination. In such cases, passengers who get off at a second or later destination will go through the destination of the passenger who got off first. Therefore, passengers who get off at the second or later destinations may experience physical strain due to fatigue from traveling. In addition, passengers who get off at the second or later destinations may feel dissatisfied because they feel they are making a detour.

Therefore, the present specification discloses a vehicle operation management system that generates and manages an operation plan for efficient allocation of vehicle while reducing the burden and dissatisfaction of passengers when there are multiple passengers who use a shared-ride vehicle.

A vehicle operation management system disclosed in the present specification includes a processor, in which the processor determines candidates for travel routes based on a boarding request including boarding location information, alighting location information, and boarding time or alighting time transmitted from a plurality of passengers, and vehicle location information, evaluates the candidates, and selects a highly-rated travel route.

The processor of the vehicle operation management system calculates a score for each of the candidates for travel routes from a weighted addition of passenger scores and operator scores, and evaluates each candidates based on the score.

The processor of the vehicle operation management system presents the selected travel route to a terminal owned by the passenger, and, in response to the passenger confirming a reservation for one of the travel routes, reflects the reservation in reservation data.

The processor of the vehicle operation management system generates an operation plan based on the reservation data.

According to the vehicle operation management system disclosed herein, by determining candidates for travel routes, evaluating the candidates, and selecting a highly-rated travel route, it is possible to generate and manage an appropriate travel plan that takes into account passenger requests and vehicle location. As a result, when there are multiple passengers using a shared-ride vehicle, efficient allocation of vehicle can be performed while reducing the burden and dissatisfaction of the passengers.

### BRIEF DESCRIPTION OF DRAWINGS

Embodiments of the present disclosure will be described based on the following figures, wherein:

FIG. 1 is a block diagram of an overall structure of a vehicle operation management system;

FIG. 2 is a flowchart depicting an example of processing of the vehicle operation management system;

FIG. 3 is a flowchart to explain details of S14 in FIG. 2;

FIG. 4 depicts an example of a travel route to illustrate calculation of scores;

FIG. 5 depicts an example of a travel route to illustrate the calculation of scores; and

FIG. 6 depicts an example of a travel route to illustrate the calculation of scores.

### DESCRIPTION OF EMBODIMENTS

A vehicle operation management system is described below with reference to the drawings. The present disclosure is not limited to embodiments described herein.

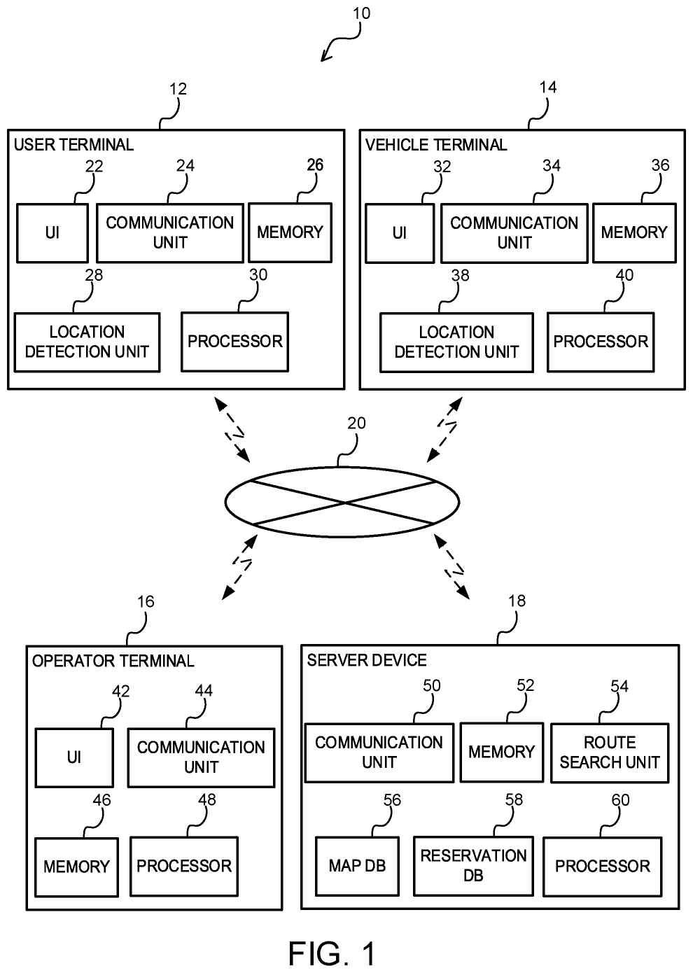

FIG. 1 is a block diagram depicting an overall structure of a vehicle operation management system. A vehicle operation management system 10 depicted in FIG. 1 is a system that generates and manages an operation plan for efficient allocation of vehicle when there are multiple passengers using a shared-ride vehicle. The vehicle operation management system 10 generates and manages an appropriate travel plan by determining candidates for travel routes based on information transmitted from the terminals described below, evaluating the candidates, and selecting the highly-rated travel route.

The “candidates for travel routes” refers to only those travel routes that satisfy certain conditions among the travel routes of the vehicle, which are determined based on the boarding and alighting locations of each passenger, when multiple passengers use a shared-ride vehicle. Here, certain conditions include, for example, whether the route is in accordance with the content of the boarding request and whether there are vehicles available for allocation of vehicles in the surrounding area. Even if there is only one “travel route,” that one travel route is a “candidate for travel routes.”

The “selection of travel routes” refers to the processing of evaluating the above candidates for travel routes and narrowing down only those candidates for travel routes for which the evaluation value is equal to or higher than the standard value. The selected travel route is the final narrowed-down route that is presented to the passengers to confirm the reservation. The selected travel routes are hereinafter referred to as “reservation candidates.”

As depicted in FIG. 1, the vehicle operation management system 10 includes a user terminal 12, a vehicle terminal 14, an operator terminal 16, and a server device 18. The user terminal 12, the vehicle terminal 14, the operator terminal 16, and the server device 18 are connected via a communication network 20.

The user terminal 12 is a terminal carried by a passenger who uses a shared-ride vehicle. As depicted in FIG. 1, the user terminal 12 has a UI 22, a communication unit 24, a memory 26, a location detection unit 28, and a processor 30.

The UI 22 is a user interface: the UI 22 presents information to the user and accepts operations from the user; the UI 22 has an output device for outputting information and an input device for inputting various kinds of data. The output device is, for example, a display having a screen display function. The input device is, for example, a touch panel, keyboard, mouse, input keys, or operation panel.

The communication unit 24 includes one or more communication interfaces with communication chips and communication circuits. The communication unit 24 exchanges information with a device that is a communication target through the communication network 20. In this example, the devices to be communicated with include the vehicle terminal 14, the operator terminal 16, and the server device 18. The communication performed by the communication unit 24 is performed using wireless communication functions such as short-range wireless communication and Wi-Fi (registered trademark).

The memory 26 includes one or more storage areas for storing data. The memory 26 is, for example, a hard disk drive (HDD), a solid state drive (SSD), various types of memory (e.g., RAM, DRAM, NVRAM, ROM, etc.), other storage devices (e.g., optical disks), or a combination thereof.

The location detection unit 28 detects the current location of a passenger carrying the user terminal 12. The location detection unit 28 includes various detection devices such as a receiver corresponding to the global navigation satellite system (GNSS), an orientation sensor, a steering angle sensor, and a distance sensor. For example, a global positioning system (GPS) receiver may be employed as a GNSS-compatible receiver. Where reception of the current location by a GPS receiver is not possible, the current location of the passenger may be detected using both an orientation sensor such as a gyro sensor and a distance sensor.

The processor 30 performs various kinds of data processing and controls the operation of various parts of the user terminal 12.

The vehicle terminal 14 is a terminal carried by the driver of a shared-ride vehicle. As depicted in FIG. 1, the vehicle terminal 14 has a (user interface) UI 32, a communication unit 34, a memory 36, a location detection unit 38, and a processor 40.

The communication unit 34, the memory 36, and the location detection unit 38 have the same functions as the communication unit 24, the memory 26, and the location detection unit 28, respectively, of the user terminal 12 described above.

Similarly, the UI 32 has the same functions as the UI 22 of the user terminal 12 described above. With respect to the UI 22 of the user terminal 12 and the UI 32 of the vehicle terminal 14, both input and output functions are used in the UI 22. On the other hand, the output function is mainly used in UI 32. In other words, the UI 22 of the user terminal 12 and the UI 32 of the vehicle terminal 14 have the differences described above. The UI 32 of the vehicle terminal 14 is mainly used for output functions to display travel routes, transit points, time and number of passengers per transit point, and passenger information based on the allocation of vehicle plan, which will be described later. On the other hand, the location information of the vehicle terminal 14 is assumed to be detected by the location detection unit 38 rather than input by the driver, thus, the input function may not be used.

The processor 40 performs various kinds of data processing and controls the operation of the various parts of the vehicle terminal 14.

The operator terminal 16 is a terminal used by operators at offices that operate shared-ride vehicles. As depicted in FIG. 1, the operator terminal 16 has a (user interface) UI 42, a communication unit 44, a memory 46, and a processor 48.

The communication unit 44 and memory 46 have the same functions as the communication unit 24 and memory 26, respectively, of the user terminal 12 described above.

Similarly, the UI 42 has the same functions as the UI 22 of the user terminal 12 described above. The input function is mainly used in the UI 42 to set up vehicles that can be used for ridesharing, set up dates and times when reservations cannot be accepted due to driver rest or vehicle inspection, and input reservations for passengers requested by phone, etc.

The processor 48 performs various kinds of data processing and controls the operation of each part of the operator terminal 16.

The server device 18 accepts information necessary for generating and managing allocation of vehicle plans from the user terminal 12, the vehicle terminal 14, and the operator terminal 16 via the communication network 20. The server device 18 then determines, evaluates, and selects candidates for travel routes based on such information, and presents the results of such selection to each terminal. As depicted in FIG. 1, the server device 18 has a communication unit 50, a memory 52, a route search unit 54, a map database (DB) 56, a reservation database (DB) 58, and a processor 60.

The communication unit 50 has the same function as the communication unit 24 of the user terminal 12 described above.

The memory 52 also has the same function as the memory 26 of the user terminal 12 described above. The memory 52 stores information received from the user terminal 12, the vehicle terminal 14, and the operator terminal 16 as data. Further, the memory 52 stores the selected travel routes and the generated allocation of vehicle plans.

The route search unit 54 generates a travel route from the boarding and alighting locations stored in the memory 52 based on the map DB information. The generated travel route is stored in the memory 52.

The map DB 56 stores map information of areas that can be traveled. The area that can be traveled is determined based on, in addition to the information stored in advance, information obtained through external communication.

The reservation DB 58 stores reservation information that has been accepted by passengers and operators (hereinafter referred to as “confirmed reservation data” as appropriate).

Processor 60 controls the operation of various parts of server device 18. In this example, the processor 60 is primarily responsible for the functions of the vehicle operation management system 10. Specifically, the processor 60 determines, evaluates, and selects candidates for travel routes based on information received from the user terminal 12, the vehicle terminal 14, and the operator terminal 16 via the communication network 20. The processor 60 then presents the selected travel routes to the user terminal 12 or the operator terminal 16 and accepts the confirmation of the reservation. The processor 60 then generates and manages the allocation of vehicle plan.

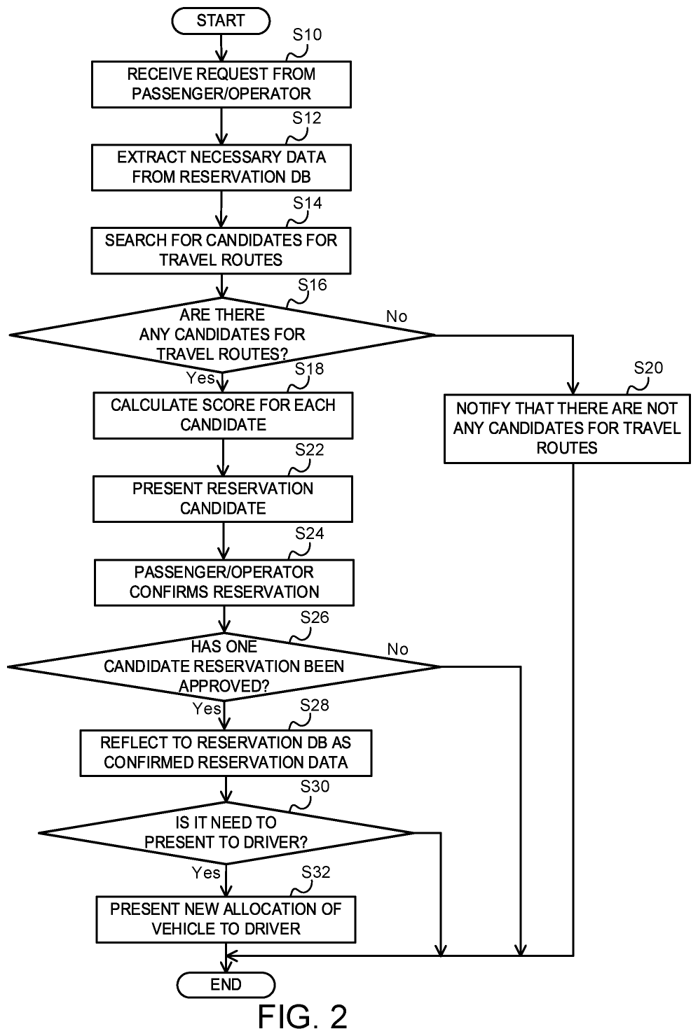

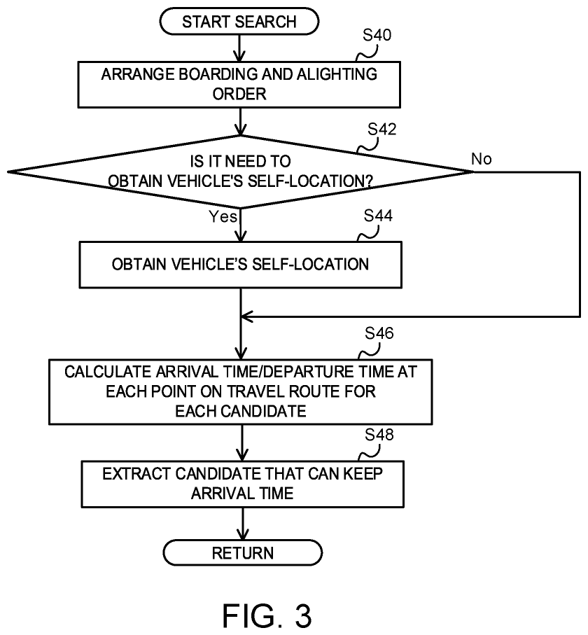

Next, FIGS. 2 and 3 are used to describe the processing in the vehicle operation management system 10 performed by the processor 60. FIG. 2 is a flowchart depicting an example of the processing of the vehicle operation management system.

First, a passenger or operator enters a vehicle reservation (hereinafter referred to as a “ride request” as appropriate) using the user terminal 12 or the operator terminal 16. Once the Ride Request is entered, the vehicle operation management system 10 performs the following processing. Processor 60 accepts the ride request transmitted from the passenger or operator (S10). The ride request includes at least the boarding location information, the alighting location information, and the boarding time or alighting time. The boarding time and the alighting time may be the boarding date and time or the alighting date and time if the reservation for the next day or later is accepted. The passenger may choose whether to include the boarding time or the alighting time in the ride request. The ride request may also include other information, such as the number of passengers. The processor 60 stores the ride request in the memory 52 as new reservation data. At this time, the processor 60 accepts the current location of the vehicle terminal 14 detected by the location detection unit 38 of each vehicle terminal 14. The processor 60 may then store the detected current location of the vehicle terminal 14 in the memory 52 as vehicle location information. The location of each vehicle may be periodically provided to the server device 18.

Next, the processor 60 extracts the necessary data from the reservation DB 58 (S12). Here, the necessary data is, for example, the confirmed reservation data that includes the times around the boarding time and around the alighting time in the ride request received in S10. The processor 60 searches for candidates for travel routes based on the contents of the new reservation data and the confirmed reservation data extracted from the reservation DB 58 (S14). The processor 60 obtains the current location and other information regarding vehicles that are not scheduled for allocation of vehicles and are on standby. The processor 60 then picks up any such standby vehicles that can be for newly allocated of vehicles. The details of this S14 processing are described below with reference to FIG. 3.

Next, the processor 60 determines whether or not candidates for travel routes exist (S16). If candidates for travel routes exist (Yes in S16), the processing proceeds to S18. If no candidates for travel routes exist (No in S16), the processor 60 notifies the passenger or operator that no candidates exist (S20). In other words, the processor 60 presents to the user terminal 12 or the operator terminal 16 that the allocation of vehicle plan cannot be generated according to the ride request because there are no candidates for travel routes.

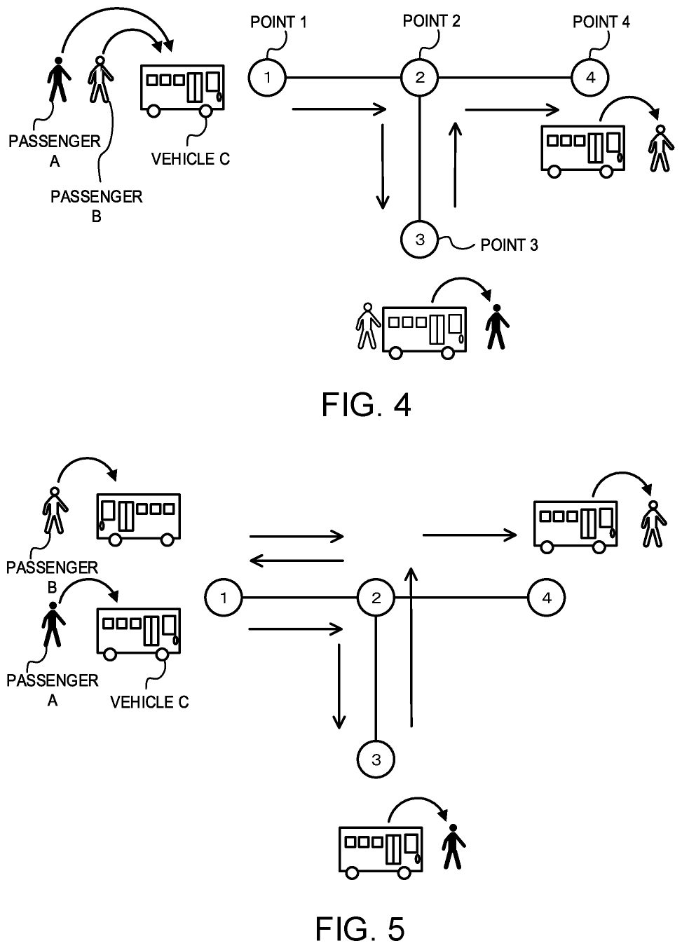

If candidates for travel routes exist, the processor 60 calculates a score for each candidate (S18). The method of calculating the score is described below with reference to FIGS. 4 to 6.

Next, the processor 60 presents the reservation candidates to the user terminal 12 or the operator terminal 16 (S22). The reservation candidates are candidates narrowed down from among candidates for travel routes according to the scores calculated in S18. For example, if there are multiple reservation candidates, the reservation candidates can be presented in the order of the highest score. Another method is to display the candidates in the order of their nearest boarding or alighting time. The score for each candidate may also be displayed as an item such as “recommendation rate.” Further, if the score is very low, the candidate with the low-rated score can be removed from the list of candidates.

Next, the passenger or operator confirms a reservation for one travel route from among the candidates for travel routes presented (S24). If there is a candidate for reservation that meets the passenger's preference, the passenger or operator confirms the reservation for one travel route as described above. This means that one candidate reservation has been approved (Yes in S26). On the other hand, if there is no candidate reservation that meets the passenger's preference (No in S26), the processing for generating the allocation of vehicle plan in question is terminated.

Then, after one candidate reservation is approved, the processor 60 stores and reflects that candidate reservation in the reservation DB 58 as confirmed reservation data (S28). The order of allocation of vehicle may change according to the newly reflected confirmed reservation data in the reservation DB 58. In such a case, the processor 60 determines whether or not notification to the driver is necessary (S30). If notification to the driver is necessary (Yes in S30), processor 60 presents the new allocation of vehicle, etc. to the vehicle terminal 14 carried by the driver (S32). On the other hand, if notification to the driver is not required (No in S30), the processor 60 terminates the series of processing.

Next, with reference to FIG. 3, the details of the processing of S14 in FIG. 2 will be explained. FIG. 3 is a flowchart for explaining details of S14 in FIG. 2.

The processor 60 searches for a travel route based on the confirmed reservation data extracted in S12 and the new reservation data accepted in S10. Then, the processor 60 arranges the boarding and alighting order of each passenger boarding a vehicle operating the travel route extracted by the search (S40). At this time, the processor 60 determines whether or not it is necessary to obtain the vehicle's self-location for the vehicle operating each travel route (S42). If vehicle's self-location is required (Yes in S42), the processor 60 obtains the current location of the vehicle as detected by the location detection unit 38 of the vehicle terminal 14 (S44). If the vehicle's self-location is not required (No in S42), the processing proceeds to S46. In other words, if the vehicle's self-location is available and does not need to be updated, the processing in S44 is skipped. However, not limited to this, the processor 60 may obtain all the self-locations of the target vehicles.

The processor 60 then calculates the arrival time and departure time at each transit point on the travel route for each vehicle operating on each travel route (S46). If there is an allocation of vehicle plan that has already been generated, the processor 60 refers to that allocation of vehicle plan and extracts as candidates for travel routes only those travel routes that can keep the arrival time (S48). For example, in the case where a passenger has already confirmed a reservation and an allocation of vehicle plan has been presented, a situation may arise later in which the arrival time is significantly delayed. In such a case, the passenger may be dissatisfied. To prevent such a situation, the processing of S48 is performed. The processor 60 then proceeds to S16.

Next, referring to FIGS. 4 to 6, the calculation of the score indicated in S18 of FIG. 2 is explained in detail. FIGS. 4 to 6 depicts examples of a travel route to illustrate the calculation of the scores.

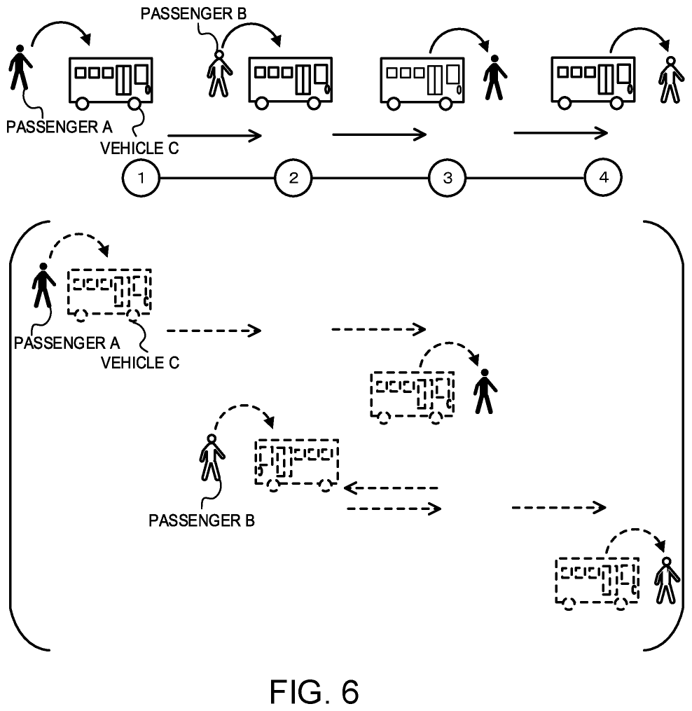

The examples depicted in FIGS. 4 and 5 depict cases in which passenger A and passenger B wish to get on from the same point 1 at the same time. In this example, vehicle C is allocated to take passengers A and B. Passenger A gets on at location 1 and gets off at location 3. Passenger B gets on at point 1 and gets off at point 4. The each length of the route between the points depicted in FIGS. 4 and 5 is 1. For example, if passenger A goes from point 1 to point 3 via point 2, the length of the route is 2. The same setup is used in FIG. 6 below.

Assume that the processor 60 has extracted two candidates for travel routes, candidate 1, which is the travel route depicted in FIG. 4, and candidate 2, which is the travel route depicted in FIG. 5. Candidate 1 in FIG. 4 corresponds to candidate 1 in Table 1 below. Candidate 2 in FIG. 5 corresponds to candidate 2 in Table 1 below. In candidate 1, passengers A and B get on vehicle C at the same time. Therefore, passenger B will go to his/her destination, point 4, after passing through point 3, which is the destination of passenger A, who gets off first. On the other hand, in candidate 2, passenger A first gets on vehicle C and gets off at destination point 3. After passenger A gets off, vehicle C will return to point 1 and let passenger B get on. Thus, passenger B will go directly to his/her destination, point 4. In the vehicle operation management system disclosed herein, after the candidates for travel routes are extracted, a score is calculated for each candidate from the weighted addition of the passenger and operator scores. The score is calculated based on the following formula (1).

$$Score = α \times passenger score + β \times operator score \qquad ( 1 )$$

$$Passenger score = ( 1 / number of passengers ) Σ net rating$$

$$Net rating of passenger A = A ’ s shortest route / A ’ s route \\ \\ \\ from boarding to alighting on candidate routes$$

$$Operator ’ s score = Shortest route among candidates / Route of candidate to be evaluated$$

Here, α and β are pre-set by design constants; the method of setting α and β is determined by the characteristics of the area, the time of day when the shared-ride vehicles are provided, the vehicle capacity, fuel consumption, and other factors. In this example, α=0.6 and β=0.4.

Table 1 below depicts the scores calculated using the above formula (1).

TABLE 1

| | Passenger score | | | Operator score | | |
|---|---|---|---|---|---|---|
| | Net rating of | Net rating of | Average of | | Operator | |
| | passenger A | passenger B | net rating | Route | score | Score |
| Candidate 1 | 1 | 0.5 | 0.75 | 4 | 1 | 0.85 |
| | (=2/2) | (=2/4) | | | (=4/4) | |
| Candidate 2 | 1 | 1 | 1 | 6 | 0.67 | 0.87 |
| | (=2/2) | (=2/2) | | | (=4/6) | |

Table 1 shows that the score of candidate 2 is higher than that of candidate 1. If the scores of candidate 1 and candidate 2 are higher than the preset standard values, both candidates are presented to passengers A and B. In addition, as mentioned above, when the method of presenting the reservation candidates is to display them in the order of their scores, candidate 2 will be presented first. Considering the above, in this example, it is considered that passenger B, who gets off later, is more likely to approve candidate 2.

Next, another specific example is depicted in FIG. 6. Suppose that processor 60 has extracted two candidates for travel routes, candidate 1, which is the travel route depicted by the solid line in FIG. 6, and candidate 2, which is the travel route depicted by the dashed line in FIG. 6. As described below, candidate 2 has a lower score. Therefore, even if candidate 2 is presented to passengers as a reservation candidate, it is unlikely to be selected. Therefore, in FIG. 6, candidate 2 is depicted as a travel route for comparison and reference, and is represented by a dashed line in parentheses. The solid line, candidate 1, corresponds to candidate 1 in Table 2 below. The dashed line, candidate 2, corresponds to candidate 2 in Table 2 below. Candidate 1 depicts the case where passenger A wishes to get on from point 1 and passenger B wishes to get on from point 2 at a time around passenger A's desired time. In this example, vehicle C is allocated of vehicle to take passengers A and B. Passenger A gets off at point 3. Passenger B gets off at location 4. On the other hand, in candidate 2, the boarding and alighting locations for passengers A and A are the same as in the example depicted in the solid line above. That is, passenger A gets on vehicle C first and gets off at the destination point 3. After A gets off, vehicle C returns to point 2 to let passenger B get on.

Table 2 below depicts the scores calculated using the above formula (1).

TABLE 2

| | Passenger score | | | Operator score | | |
|---|---|---|---|---|---|---|
| | Net rating of | Net rating of | Average of | | Operator | |
| | passenger A | passenger B | net rating | Route | score | Score |
| Candidate 1 | 1 | 1 | 1 | 3 | 1 | 1.0 |
| | (=2/2) | (=2/2) | | | (=3/3) | |
| Candidate 2 | 1 | 1 | 1 | 5 | 0.60 | 0.84 |
| | (=2/2) | (=2/2) | | | (=3/5) | |

Table 2 shows that the score of candidate 2 is higher than that of candidate 1. The difference in the scores of each candidate shown in Table 2 is more pronounced than the difference in the scores of each candidate depicted in Table 1. The results in Table 2 show the effectiveness of combining the operator's score when calculating the score. In other words, if we focus only on the passenger score, candidates 1 and 2 both have a score of 1. In this case, candidate 2 can be selected with the same probability as candidate 1. However, candidate 2, which allows passenger A to get on first and then turns around and allows passenger B to get on, is not desirable from the viewpoint of efficient allocation of vehicle C. However, as in the vehicle operation management system disclosed herein, the score is calculated after combining the operator's score as well. As a result, it is possible to reduce the burden and dissatisfaction of passengers while at the same time ensuring efficient allocation of vehicle.

The functions of the vehicle operation management system 10 described above are realized by the cooperation of hardware and software as an example. For example, the functions of each device are realized by the processor 60 reading and executing a program stored in the memory of each device. The program is stored in the memory via a recording medium such as a CD or DVD, or via a communication path such as a network.

As described above, in the vehicle operation management system disclosed herein, a score is calculated from the weighted addition of passenger and operator scores for each candidate for travel routes, and that candidates are evaluated based on the scores. Therefore, the vehicle operation management system disclosed herein enables efficient allocation of vehicles, which is difficult to achieve when only passenger scores are considered.

The description so far is an example. In the vehicle operation management system disclosed herein, it is sufficient that the processor determines candidates for travel routes, evaluates them, and selects a highly-rated travel route based on ride requests transmitted from multiple passengers and location information of the vehicle. Therefore, other processes that are mainly performed by the processor 60 in the vehicle operation management system 10 may be modified as appropriate. For example, in S10 depicted in FIG. 2, the processor 60 may set the nearest available ride location from the location information of the user terminal 12 instead of the ride location when accepting a ride request from a passenger or operator.

### REFERENCE SIGNS LIST

10 vehicle operation management system, 12 user terminal, 14 vehicle terminal, 16 operator terminal, 18 server device, 20 communication network, 50 communication unit, 52 memory, 54 route search unit, 56 map DB, 58 reservation DB, 60 processor.

1. A vehicle operation management system comprising:
a processor, wherein
the processor determines candidates for travel routes based on a boarding request including boarding location information, alighting location information, and boarding time or alighting time transmitted from a plurality of passengers, and vehicle location information, evaluates the candidates, and selects a highly-rated travel route.

2. The vehicle operation management system according to claim 1, wherein
the processor calculates a score for each of the candidates for travel routes from a weighted addition of passenger scores and operator scores, and evaluates each candidates based on the score.

3. The vehicle operation management system according to claim 2, wherein
the processor presents the selected travel route to a terminal owned by the passenger, and, in response to the passenger confirming a reservation for one of the travel routes, reflects the reservation in reservation data.

4. The vehicle operation management system according to claim 3, wherein
the processor generates an operation plan based on the reservation data.
